(19) United States
(12) Patent Application Publication
(10) Pub. No.: US 2004/0181388 A1
(43) Pub. Date: Sep. 16, 2004

(54) System having tape drive emulator and data tape cartridge housing carrying multiple disk drives

(76) Inventors: Yung Yip, Afton, MN (US); James R. Kramlich, Oakdale, MN (US); Robert W. Tapani, Oakdale, MN (US)

Correspondence Address: Imation Corp., PO Box 64898, St. Paul, MN, 55164-0898, US

(21) Appl. No.: 10/385,786

(22) Filed: Mar. 11, 2003

(51) Int. Cl. G06F 9/455

(52) U.S. Cl. 703/25; 369/13.37

(57) ABSTRACT

A system is described including a disk-based data cartridge that contains a plurality of disk drives, and that physically conforms to industry standard dimensions for magnetic data tape cartridges. A tape drive emulator receives the disk-based data cartridge and stores data within the plurality of disk drives in accordance with a format that emulates a tape storage format. A controller within the tape drive emulator utilizes RAID techniques to store data on the plurality of disk drives, thereby achieving increased performance, fault tolerance, or combinations thereof. A host computing device communicates the data to the tape drive emulator via a tape drive communication protocol. An automation unit selectively retrieves the disk-based data cartridge from a data tape cartridge library and engages the disk-based data cartridge with the tape drive emulator.

### TECHNICAL FIELD

The invention relates to data storage devices.

### BACKGROUND

A conventional data tape cartridge consists of a tape, i.e., an elongated flexible medium having a magnetic recording layer, wound on one or more reels or hubs. Data is recorded and retrieved by inserting the data tape cartridge within a tape drive and passing the recording medium in front of one or more read/write heads. Tape drives are usually streaming devices in which data is recorded in serpentine fashion as the tape streams back and forth. In particular, the tape drive typically writes the data along a number of tracks that span the length of the medium.

Automated cartridge libraries provide access to vast amounts of electronic data by managing magnetic data tape cartridges. Automated cartridge libraries exist in all sizes, ranging from small library systems that may provide access to twenty or fewer data cartridges, to larger library systems that may provide access to thousands of data cartridges.

In a conventional automated cartridge library system, an automation unit, such as a robotic arm or other mechanism, typically services a plurality of data cartridge storage locations. The automation unit selectively retrieves a data cartridge from one of the storage locations and loads the retrieved data cartridges into a designated tape drive to access data stored by the data cartridge. Each data cartridge typically has some kind of identifying information, such as a label, a bar code, or a radio frequency (RF) tag, by which the automation unit identifies the individual tape cartridges.

When the tape drive is finished with the data cartridge, the automation unit retrieves the data cartridge from the tape drive and returns it to the assigned data cartridge storage location. A host computing system communicates with a library control unit that typically controls the operation of the automated cartridge library. In this way, a large number of data cartridges are automatically accessible by one or more tape drives.

To manipulate a data cartridge, the automation unit typically includes an interface that engages the data cartridge and allows the automation unit to convey and manipulate the orientation of the tape cartridge. For example, the automation unit may comprise a robotic arm that includes a gripper that grasps the selected data cartridge. Because the data cartridges must be positioned in a precise manner for the robotic arm to grasp them correctly, the data cartridges and the storage locations are constructed with exact dimensions. Accordingly, the data cartridges of the library system typically have substantially similar, if not identical, form factors to be received by the interface of the automation unit.

### SUMMARY

In general, the invention is directed to non-tape based emulation of data tape cartridges. More specifically, as the form factor for disk drives continues to be reduced, it becomes possible to embed multiple disk drives within a housing of a conventional data tape cartridge. Moreover, the data tape cartridge housing carrying multiple disk drives, referred to herein as a “disk-based data cartridge,” may be used with a tape drive emulator to receive the disk-based data cartridge, and present the disk-based data cartridge to a host computing device as a conventional sequential storage device. As a result, the host computer device may utilize the disk-based data cartridge as a conventional magnetic data tape cartridge.

In one embodiment, a device comprises a data tape cartridge housing, and a plurality of disk drives contained within the data tape cartridge housing.

In another embodiment, a tape drive emulator comprises a controller to store data on a plurality of disk drives contained within a data tape cartridge housing.

In another embodiment, a system comprises a data tape cartridge, a tape drive emulator, a host computing device, and an automation unit. The data tape cartridge includes a housing that contains a plurality of disk drives, and that conforms to industry standard dimensions for magnetic data tape cartridges. The tape drive emulator receives the data tape cartridge housing and stores data within the plurality of disk drives in accordance with a format that emulates a tape storage format. The host computing device communicates the data to the tape drive emulator via a tape drive communication protocol. The automation unit selectively retrieves the data tape cartridge from a data tape cartridge library and engages the data tape cartridge with the tape drive emulator.

In another embodiment, a system comprises a plurality of tape drive emulators to receive data tape cartridge housings that contain one or more non-tape storage media and that conform to industry standard dimensions for magnetic data tape cartridges. The tape drive emulators receive the data tape cartridges and store data within the contained non-tape storage media in accordance with a format that emulates a tape storage format. A host computing device communicates the data to the tape drive emulators via a tape drive communication protocol. The host computing device includes a Redundant Array of Independent Disks (RAID) controller to control storage of the data to the tape drive emulators.

In another embodiment, a method comprises receiving data from a host computing device in accordance with a tape drive communication protocol, and storing the data on a plurality of disk drives carried by a data tape cartridge housing in accordance with a selectable storage mode.

The invention may be capable of providing a number of advantages. The techniques and storage format described herein may allow a tape drive emulator to efficiently respond to commands received from a host computing device in accordance with a conventional tape storage protocol. Consequently, the techniques allow the non-tape storage medium to appear to the host computing device as a conventional sequential storage device. The techniques allow a non-tape storage medium to store data in a format that emulates linear tape storage, yet supports high-speed, random access to the stored data.

Moreover, the use of multiple disk drives within a single data cartridge housing allows the emulation to achieve increased performance. For example, the disk drives may be utilized to achieve increased data transfer rates by writing data to the disk drives in parallel. Furthermore, the multiple disk drives may provide increased capacity over a single disk drive. In addition, the disk drives may be utilized to provide robust data integrity by, for example, redundantly mirroring data to each of the internal disk drives.

In addition, by making use of the invention, an automated data tape cartridge system may include a number of conventional data tape cartridges housing magnetic tape, as well as a number of data tape cartridges housing non-tape media. Regardless of the type of internal storage media, the data tape cartridges may have housings conforming to standard dimensions and features to be easily manipulated by the automation system. In this manner, the mechanical interfaces between the automation systems need not be adapted or upgraded to support data tape cartridges having non-tape media. In other words, because the data tape cartridges conform to standard dimensions, data tape cartridges housing different types of media can be mechanically indistinguishable by the automation system. Accordingly, the automated data tape cartridge system may readily include tape drives for accessing conventional data tape cartridges and tape drive emulators for accessing data tape cartridges having non-tape media.

Furthermore, the data tape cartridges housing non-tape storage media may be self-contained storage devices that include necessary electronics and control circuitry for accessing the storage media. For example, a data tape cartridge may have standard external dimensions and features of a data tape cartridge, but may house one or more disk drives including the disk-shaped storage media as well as one or more the disk drive controllers and read/write circuitry.

In addition, the tape drive emulator receives a data tape cartridge carrying the non-tape storage medium and translates commands and performs other operations such that the data tape cartridge appears as a conventional sequential storage device to the host computing device. In this manner, the non-tape storage medium physically appears the same as a magnetic data tape cartridge from the perspective of the automation system, and functionally appears the same from the perspective of the host computing device.

The external electrical connector of the data tape cartridge and the socket of the tape drive provide a robust electrical connection between the tape drive emulator and the data tape cartridge. Accordingly, a wide variety of storage media may be used within a library automation system with little or no change to the automation unit or the host computing device, thereby expanding the capabilities of the tape library automation system.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system in which a disk-based data cartridge stores data on a plurality of internal disk drives in a format that emulates a tape storage format.

FIG. 2 is an exploded perspective view of an exemplary embodiment of the disk-based data cartridge housing and of FIG. 1.

FIG. 3 is a cross-sectional side view of the exemplary embodiment of the disk-based cartridge illustrated in FIG. 2.

FIG. 4 is a block diagram illustrating example embodiments of a tape drive emulator that receives a disk-based data cartridge.

FIG. 5 is a block diagram illustrating an example embodiment of a self-contained disk drive that may be incorporated within a data tape cartridge housing.

FIG. 6 is a block diagram illustrating an example system in which RAID functionality is incorporated directly within an exemplary disk-based data cartridge.

FIG. 7 is a block diagram illustrating an example system in which a host computing device applies Redundant Array of Independent Disks (RAID) functionality to a plurality of tape drive emulators as if the tape drive emulators where conventional tape drives.

FIG. 8 is a block diagram illustrating an example automated data tape cartridge library system.

### DETAILED DESCRIPTION

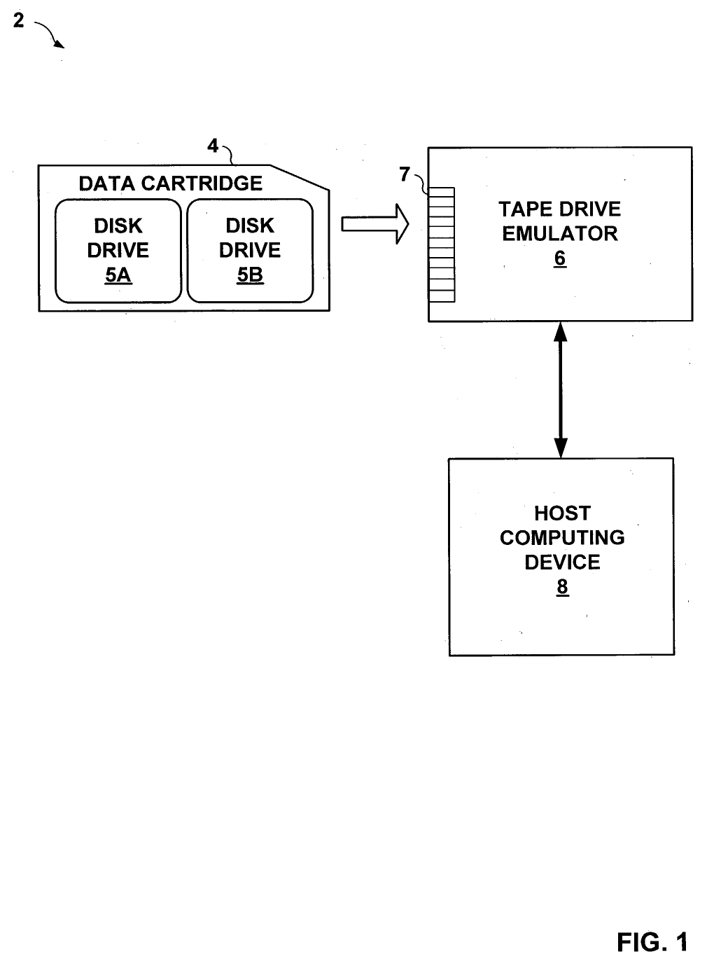

FIG. 1 is a block diagram illustrating a system 2 in which a disk-based data cartridge 4 stores data on a plurality of internal disk drives 5A, 5B (“disk drives 5”) in a format that emulates a tape storage format. Tape drive emulator 6 receives disk-based data cartridge 4, and provides access to disk drives 5 as a conventional tape drive. In other words, tape drive emulator 6 communicates with host computing device 8 in accordance with a tape storage protocol, thereby allowing disk drives 5 to appear to host computing device 8 as a conventional sequential storage device.

In response to a query from host computing device 8, tape drive emulator 6 may identify itself as a conventional tape drive, such as a standard 3480 tape drive. Consequently, the drivers and other software applications that may reside on host computing device 8 for accessing conventional tape-based data tape cartridges need not be modified to access disk drives 5 within disk-based data cartridge 4. Tape drive emulator 6 and host computing device 8 may communicate in accordance with a conventional protocol used by tape backup systems, such as Small Computer System Interface (SCSI), or other protocol.

Tape drive emulator 6 receives commands and data from host computing device 8. For example, tape drive emulator 6 may receive data access commands, positioning commands, and the like. Tape drive emulator 6 translates the typical sequential data structures associated with the commands into a format useable for disk drives 5. More specifically, tape drive emulator 6 translates the sequential data structures typically associated with a tape storage medium into a format compatible with the cylinder and head format typically used by disk drives 5.

These approaches may be advantageous in that each of disk drives 5 may comprise a self-contained disk drive embedded within disk-based data cartridge 4 that may manage the mapping of logical block addresses to physical block addresses. Consequently, tape drive emulator 6 need only manage the quantity and locations of the logical storage space used to store the data in the format for efficient emulation of a tape storage medium.

The techniques and storage format described herein may allow tape drive emulator 6 to efficiently respond to commands received from host computing device 8 in accordance with a conventional tape storage protocol. As a result, disk-based data cartridge 4 and, more specifically, disk drives 5 may store data in a format that emulates linear tape storage, yet support high-speed, random access to the stored data. Moreover, the use of multiple disk drives 5 within disk-based data cartridge 4 can achieve increased emulation performance. For example, disk drives 5 may be utilized to achieve increased data transfer rates by writing data to the disk drives in parallel. Furthermore, disk drives 5 may provide increased capacity over a single disk drive or other non-tape storage medium used for tape emulation. In addition, disk drives 5 may be utilized to provide robust data integrity by, for example, redundantly mirroring data to each of the internal disk drives.

Tape drive emulator 6 includes a socket 7 for receiving disk-based data cartridge 4. As illustrated below, socket 7 provides an electrical interface for accessing disk drives 5 contained with disk-based data cartridge 4. In particular, disk-based data cartridge 4 may house a plurality of fully self-contained disk drives, including all necessary electronics and control circuitry for accessing the non-tape storage medium. For example, each disk drive 5 may include one or more disk-shaped storage media, as well as a disk drive controller, actuator, magnetic transducer, pre-amplifiers and read/write circuitry.

Disk-based data cartridge 4 may include a housing that conforms to standard external dimensions and features of magnetic data tape cartridges. For example, the external dimensions of disk-based data cartridge 4 may conform to one of a number of industry-standard form factors, such as the form factors of the Black Watch™ 9840 and Royal Guard™ 3480, 3490E, 3490EL and 9490EE magnetic storage tape cartridges manufactured by Imation Corp. of Oakdale, Minnesota.

Tape drive emulator 6 may have a form factor of a standard tape drive such that the location of socket 7 conforms to the location of a slot within the standard tape drive. In this manner, automation equipment within a data tape cartridge library system, as described below, may readily insert and remove disk-based data cartridge 4 without requiring modification to tape drive emulator 6 or the automation equipment.

In accordance with a conventional tape storage protocol, host computing device 8 may use a variety of different types of tape marks depending on the drive mechanism, medium format, and the software used to write the data to tape drive emulator 6. Examples of typical tape marks that may be used by host computing device 6 include file marks, sequential file marks, block marks, end-of-data marks, and the like. Tape drive emulator 6 may write the data sequentially within the storage areas of disk drives 5. While writing the data, tape drive emulator 6 may maintain a library of tape marks based on the tape marks received from host computing device 8. Specifically, tape drive emulator 6 may maintain the library of tape marks to emulate the tape marks used by host computing device 8 as if communicating with a conventional tape drive. The library associates the recorded tape mark with a position or offset within the data. Consequently, tape drive emulator 6 may use the tape mark library to indicate locations of the files, data blocks, end of data, and the like, and may readily respond to positioning commands from host computing device 8 that make use of the tape marks. To access a specific data file, tape drive emulator 6 need only access the library of tape marks to identify a target file mark associated with the data file, and map the target file mark to a starting one of the logical storage areas for immediate access to the stored data.

These techniques may advantageously allow tape drive emulator 6 to respond to a variety of tape access commands received from host computing device 8, including those commands that specify tape marks. For example, tape drive emulator 6 may receive a command to advance or rewind a tape a specified number of file marks. In response, tape drive emulator 6 need only access the library of tape marks to identify a target tape file mark.

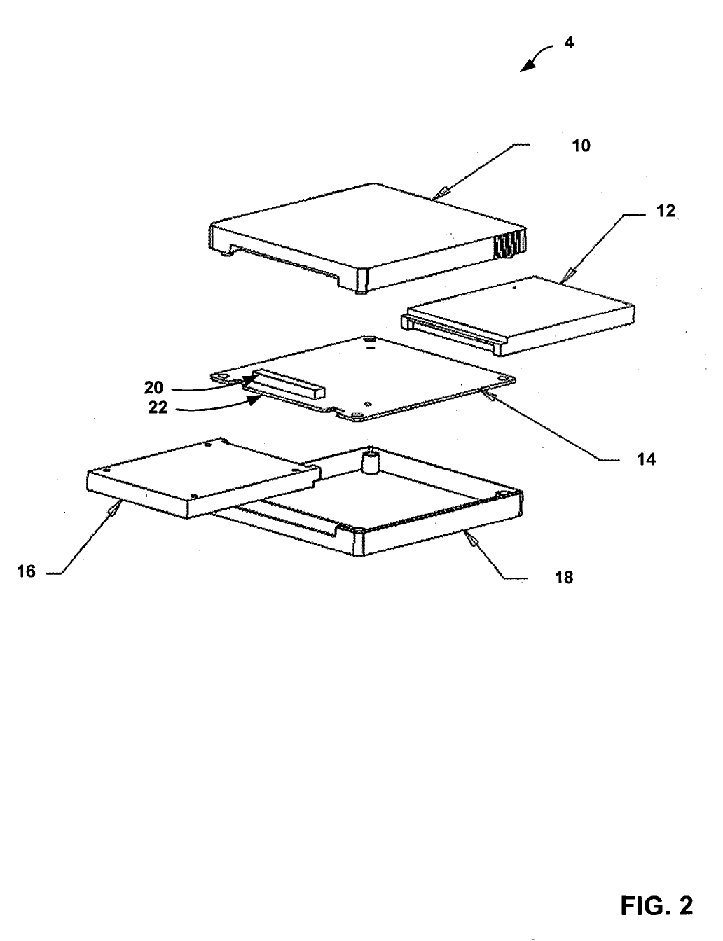

FIG. 2 is an exploded perspective view of an exemplary embodiment of disk-based data cartridge 4. More specifically, disk-based data cartridge 4 includes an outer housing formed by an upper cover 10 and a lower cover 18 that contains a first disk drive 12, a printed circuit 14, and a second disk drive 16.

Disk drive 12 electrically engages printed circuit 14 via an electrical connector 20 connected to an upper surface of the printed circuit. Printed circuit 14 may be, for example, a printed circuit board, a printed circuit on a flexible membrane, and the like. Disk drive 16 may be oriented opposite in direction from disk drive 12, i.e., rotated horizontally 180 degrees, and may similarly engage an electrical connector (not shown) on a lower surface of the printed circuit. Printed circuit 14 includes an electrical edge connector 22 for electrically engaging socket 7 of tape drive emulator 6.

In one embodiment, housing formed by upper cover 10 and lower cover 18 may have a length of approximately 125 mm, a width of approximately 110 mm, and a height of approximately 24 mm, which is typical for conventional data tape cartridges. As the form factor for conventional disk drives continues to be reduced, it becomes possible to embed multiple disk drives, e.g., disk drives 12, 16, within the housing of disk-based data cartridge 4. For example, in one embodiment, each of disk drives 12, 16 may have lengths of approximately 100 mm, widths of approximately 70 mm, and heights of approximately 10 mm. As a result, disk drives 12, 16 may be stacked, as illustrated in FIG. 2, to leave at least 4 mm of vertical space sufficient for housing printed circuit 14.

The embodiment of FIG. 2 is illustrated for exemplary purposes only. It is expected that additional disk drives may be contained within the housing of data cartridge 4 as the form factor of conventional disk drives continues to be reduced. For example, it is expected that disk drives of less than one inch in length will be commercially available in the near future. As a result, disk drives may be arranged in disk-based data cartridge 4 length-wise, width-wise, stacked, or combinations thereof, so as to achieve an increased number of disk drives within the data tape cartridge.

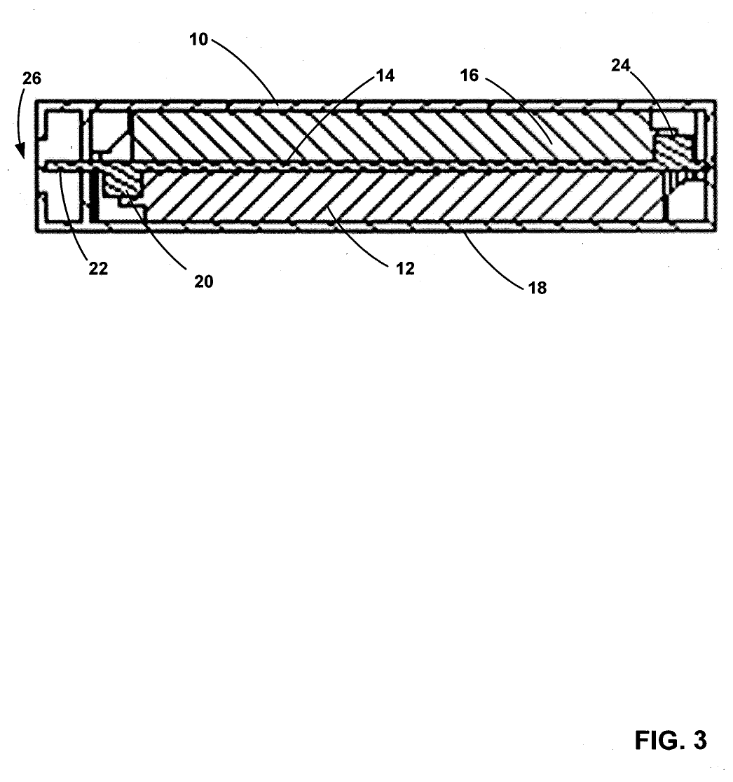

FIG. 3 is a cross-sectional side view of the exemplary embodiment of the disk-based data cartridge 4 illustrated in FIG. 2. As illustrated, upper cover 10 and bottom cover 18 form an access hole 26 by which tape drive emulator 6 electrically engages edge connector 22 of printed circuit 14. Moreover, printed circuit 14 is sandwiched between hard disks 12, 16, and includes electrical connectors 20, 24 oriented on opposite surfaces of printed circuit 14 for engaging the respective disk drives.

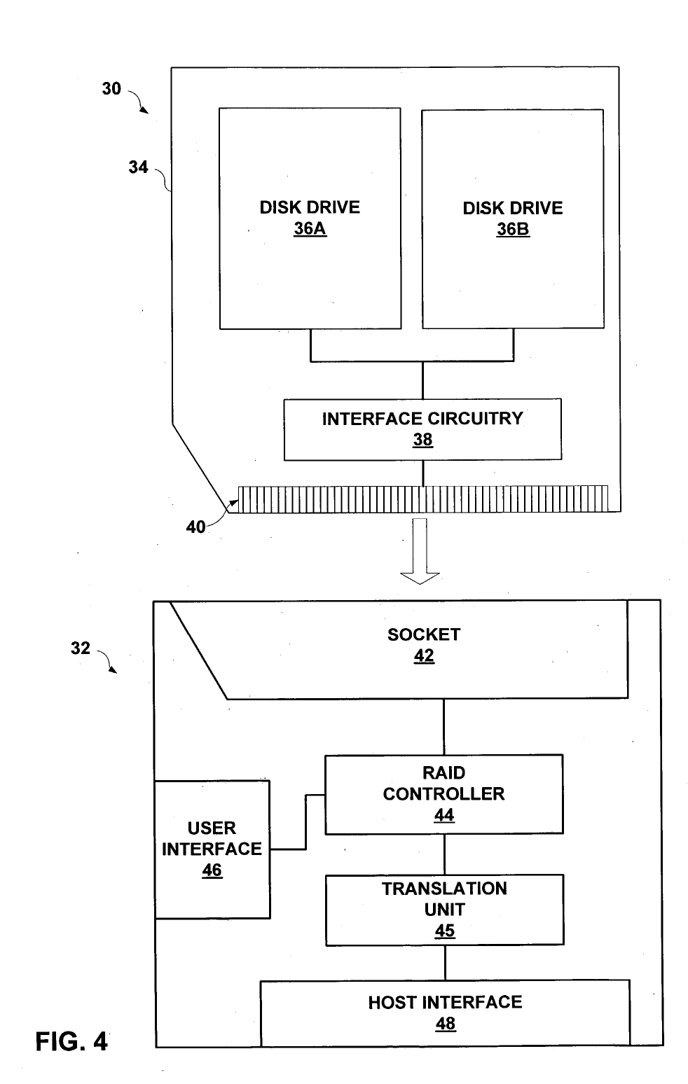

FIG. 4 is a block diagram illustrating example embodiments of tape drive emulator 6 (FIG. 1), e.g., a tape drive emulator 32, and a disk-based data cartridge 30 having a plurality of disk drives 36A, 36B (“disk drives 36”). Specifically, cartridge 30 includes a housing 34 that forms an enclosure for disk drives 36 and various other components. Each of disk drives 36 may be self-contained disk drives, such as a hard disk, that include a disk drive controller and read/write circuitry, and at least one disk-shaped storage medium, such as a magnetic medium, an optical medium, a magneto-optic medium, a holographic medium, various combinations of media, and the like. In short, the invention may find useful application with any of a wide variety of non-tape media.

Disk drives 36 communicate with emulator 32 via interface circuitry 38. Interface circuitry 38 may implement a non-conventional communications protocol, or may implement any standard interface protocol, such as the Small Computer System Interface (SCSI), the Fibre Channel interface, the Enhanced Integrated Drive Electronics/AT Attachment (EIDE/ATA) interface, Serial ATA, or the like. In this manner, disk-based data cartridge 30 may comprise a plurality of fully self-contained disk drives 36, as may be purchased as off-the-shelf components from one of a number of disk drive manufactures, such as Seagate Technology of Scotts Valley, Calif.

Although illustrated as self-contained disk drives, disk-based data cartridge 30 may include only a portion of the drive electronics for accessing a plurality of disk storage media. For example, tape drive emulator 32 may include one or more disk drives controllers and interface circuitry to reduce the cost and weight of disk-based data cartridge 30, which may be advantageous for high-volume applications.

Electrical connector 40 provides an externally available electrical interface for coupling to tape drive emulator 32 upon insertion. In particular, electrical connector 40 provides input/output electrical pins for communicating with, and receiving power from, tape drive emulator 32.

Tape drive emulator 32 includes socket 42 to make a robust electrical connection to electrical connector 40 of disk-based data cartridge 30 upon insertion. In one embodiment, socket 42 may comprise a zero insertion force (ZIF) socket. In particular, socket 42 may include a set of connectors operable to clamp and release electrical connector 40. Tape drive emulator 32 may, for example, mechanically actuate the connectors of socket 42 in response to sensing the insertion of the electrical connector of the data tape cartridge. Alternatively, a gripper of an automation library may actuate a lever or other mechanical actuator of socket 42 to clamp down on and release the disk-based data cartridge 30. The layout of the mechanical connectors of socket 42 and the pins of connector 40 may take any one of a number of forms, such as array-shaped, staggered or inline.

As illustrated, tape drive emulator 32 includes a RAID (Redundant Array of Independent Disks) controller 44 to control the storage and retrieval of data from disk drives 36. More specifically, RAID controller 44 utilizes disk drives 36 in combination to achieve improved fault tolerance, performance or both. Based on input received from a system administrator or other user via user interface 46, RAID controller 44 may be placed in one of a number of data storage modes. User interface 46 may include, for example, a small liquid crystal display (LCD), an LCD controller, a touch pad or other input device, and the like.

In a first mode, RAID controller 44 may utilize data striping across disk drives 36. More specifically, blocks of each file to be stored are spread across disks 36 without redundancy. This mode does not improve fault tolerance, but may provide increased performance as the data may be written to disk drives 36 in parallel. Moreover, increased capacity may be achieved as redundant data is not written, allowing full utilization of the storage space of drives 36. This type of functionality in conventional disk-based systems is often referred to as RAID level zero.

In a second mode, RAID controller 44 may provide data mirroring across disk drives 36. In this mode, RAID controller 44 may redundantly mirror data to each of the internal disk drives 36. More specifically, RAID controller 44 may write original data to disk drive 36A, while writing a copy of the data to disk drive 36B. In the event disk drive 36A fails or otherwise is corrupted or inaccessible, RAID controller 44 may retrieve data from disk drive 36B.

Although illustrated for exemplary purposes with two disk drives 36, additional disk drives may be incorporated to provide increased functionality. If more than two disk drives 36 are present, for example, RAID controller 44 may provide data striping across a subset of the drives, e.g., two drives, and reserve one of the drives for error correction data. In this manner, RAID controller 44 may achieve increased performance and some level of fault tolerance.

If nine or more disk drives 36 are present, RAID controller 44 may provide data striping at the byte level across a plurality of drives, and also stripe error correction information on the remaining drives. This may result in excellent performance and good fault tolerance.

In this manner, tape drive emulator 32 and RAID controller 44 may utilize disk-based data cartridge 30 and disk drives 36 in a variety of ways. to achieve increased performance, fault tolerance, and storage capacity, yet support a format that emulates linear tape storage to appear as a linear storage device.

Host interface 48 provides an electrical interface between tape drive emulator 32 and host computing device 8 (FIG. 1). Host interface 48 may conform to any one of a number of standard communications interfaces such as the Small Computer System Interface (SCSI), the Fiber Channel interface, the Network Data Management Protocol (NDMP), the Enhanced Integrated Drive Electronics/AT Attachment (EIDE/ATA) interface, or the like.

Tape drive emulator 32 may include a translation unit 45 for translating commands received from host interface 48 prior to delivering the commands to RAID controller 44. For example, translation unit 45 may receive commands from host interface 48 that are typical for sequential access devices, such as tape drives, and may translate the commands into commands that are more typical for disk drives or other storage devices. Translation unit 45 stores the data in logical storage areas managed by disk drive controller 46. In addition, translation unit 45 may provide data buffering, compression and decompression, data reformatting, error detection and correction, and the like, in order to provide a tape drive interface to host computing device 8 and a non-tape interface to the disk-based data cartridge 30. In this manner, tape drive emulator 32 allows data tape cartridge carrying a non-tape storage medium to appear to host computing device 8 as a sequential storage device.

Furthermore, translation unit 45 allows host interface 48 and electrical connector 40 of disk-based data cartridge 30 to conform to different interface specifications. For example, translation unit 45 may support a SCSI interface between tape drive emulator 32 and host computer device 8, and an EIDE interface between tape drive emulator 32 and disk-based data cartridge 30. Translation unit 45 may comprise one or more custom application-specific integrated circuits. Alternatively, translation unit 45 and RAID controller 44 could be implemented as a single board computer or an application-specific integrated circuit (ASIC).

Although described in reference to disk-based tape emulation, the invention is not so limited. For example, data tape cartridge 34 may comprise a plurality of other non-tape storage media for utilization by RAID controller 44 in a similar manner. One example of other types of storage media that may be embedded within data cartridge 30 includes solid-state storage media.

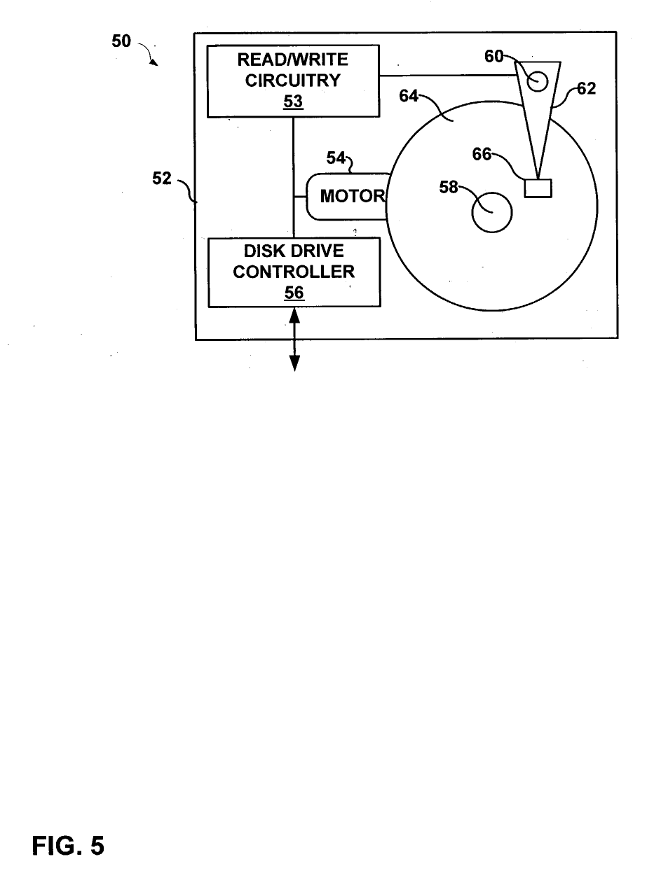

FIG. 5 illustrates an example. embodiment of a self-contained disk drive 50 that may be incorporated within a disk-based data cartridge. In the exemplary embodiment, disk drive 50 contains a storage medium 64 that may be any disk-shaped storage medium such as magnetic, optic, magneto-optic and the like. Spindle motor 54 rotates magnetic storage medium 64 around spindle hub 58. Actuator 62 rotates around actuator shaft 60, causing transducer 66 to traverse the rotating magnetic storage medium 64 for reading and writing data.

Disk drive controller 56 controls read/write circuitry 53 and actuator 62 to output signals to, and sense signals from, transducer 66. Disk drive controller 56 communicates with tape drive emulator 32 (FIG. 4) via interface 40, in accordance with a non-conventional communications protocol or any standard interface protocol, such as the Small Computer System Interface (SCSI), the Fibre Channel interface, the Enhanced Integrated Drive Electronics/AT Attachment (EIDE/ATA) interface, Serial ATA, or the like. In this manner, data tape cartridge disk drive 50 may be a fully self-contained unit that may be purchased as an off-the-shelf component from one of a number of disk drive manufactures.

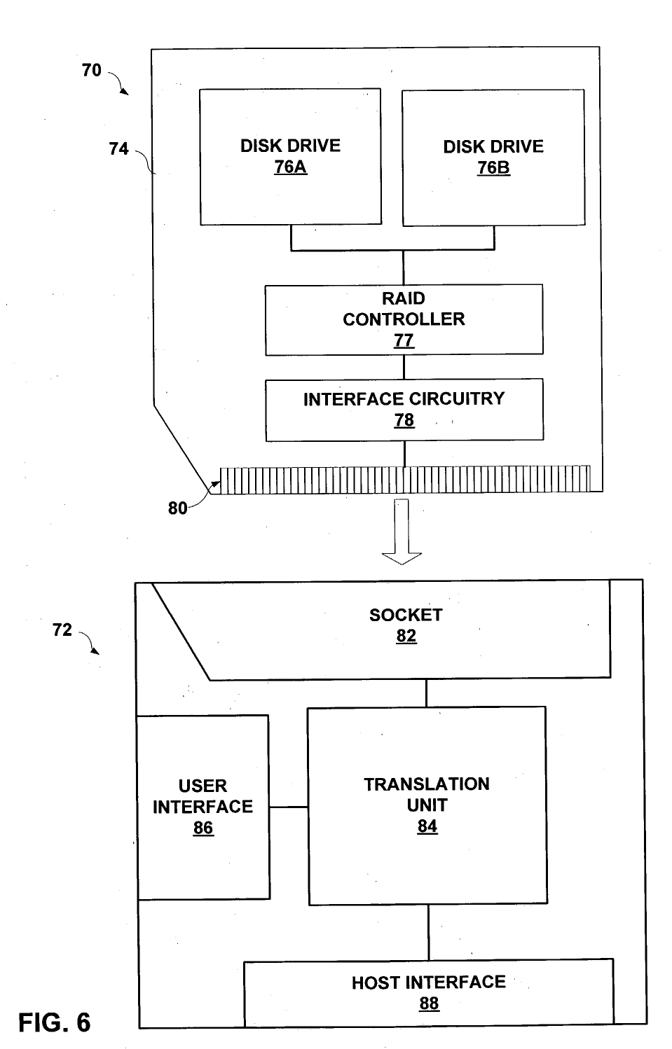

FIG. 6 is a block diagram illustrating an example system 70 in which RAID functionality is incorporated directly within an exemplary data tape cartridge 74. In a manner similar to data tape cartridge 34 of FIG. 4 described above, disk-based data cartridge 70 includes a housing 74 that forms an enclosure for a plurality of disk drives 76A, 76B, (“disk drives 76”), interface circuitry 78, and electrical connector 80 for engaging tape drive emulator 72. Furthermore, similar to data tape cartridge 32 of FIG. 4, data tape cartridge 72 includes a socket 82, a translation unit 84, a user interface 86, a user interface 86, and a host interface 88.

In the exemplary embodiment of FIG. 6, data tape cartridge 74 includes RAID controller 77 that utilizes disk drives 76 in combination to achieve improved fault tolerance, performance or both. In other words, RAID functionality may be embedded directly within the data tape cartridge, e.g., data tape cartridge 74. Tape drive emulator 72 may provide configuration input received from a system administrator or other user via user interface 86 to data tape cartridge 74 to place RAID controller 77 in one of a number of data storage modes, e.g., RAID level zero, RAID level one, RAID level three, RAID level five, and the like, depending on the desired functionality and the number of disk drives 76 contained within the data tape cartridge.

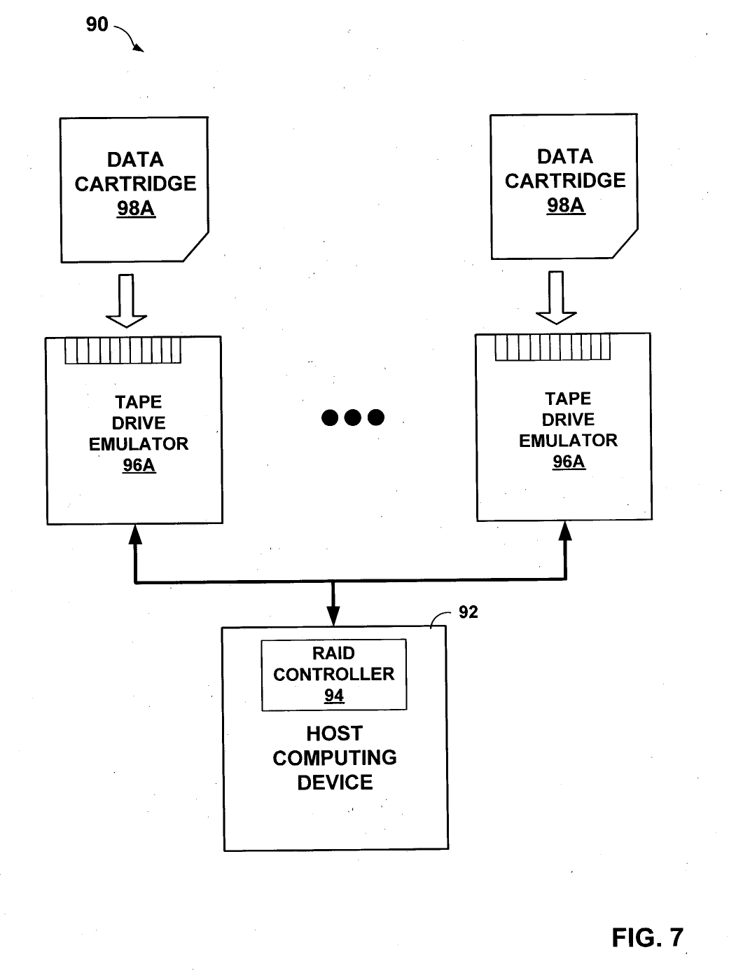

FIG. 7 is a block diagram illustrating an exemplary system 90 in which a host computing device 92 applies RAID functionality to a plurality of tape drive emulators 96 as if the tape drive emulators were conventional tape drives. Host computing device 92 communicates with the tape drive emulators in accordance with a conventional tape data storage protocol as if tape drive emulators 96 were conventional sequential storage devices. Moreover, host computing device 92 includes RAID controller 94 that applies RAID techniques when storing data to tape drive emulators 96. In particular, RAID controller 94 interacts with tape drive emulators 96 as if the tape drive emulators were conventional tape drives, and applies RAID functionality to achieve increased performance, fault tolerance, or combinations thereof

Tape drive emulators 96 receive data tape cartridges 98, which may comprise one or more non-tape storage media, such as a self-contained disk drive. In this manner, host computing device 92 and RAID controller 94 may store data to data tape cartridges using conventional RAID techniques as otherwise applied to conventional tape drives. The use of tape drive emulators 96 and data tape cartridges having non-tape storage media, however, allows system 90 to achieve high-speed, random access to the stored data.

These techniques may be particularly useful in automation libraries or other environment where tape drive emulators 96 may be used alongside conventional tape drives. In these systems, host computing device 92 may apply conventional RAID techniques to tape drives, yet system 90 may achieve high-speed, random access to the extent tape emulation is employed. Moreover, all of data tape cartridges 98 need not contain disk-based storage media, but may contain non-tape storage media of a variety of forms, such as disk-shaped magnetic storage media, solid-state storage media, optical storage media, magneto-optical storage media, and holographic storage media.

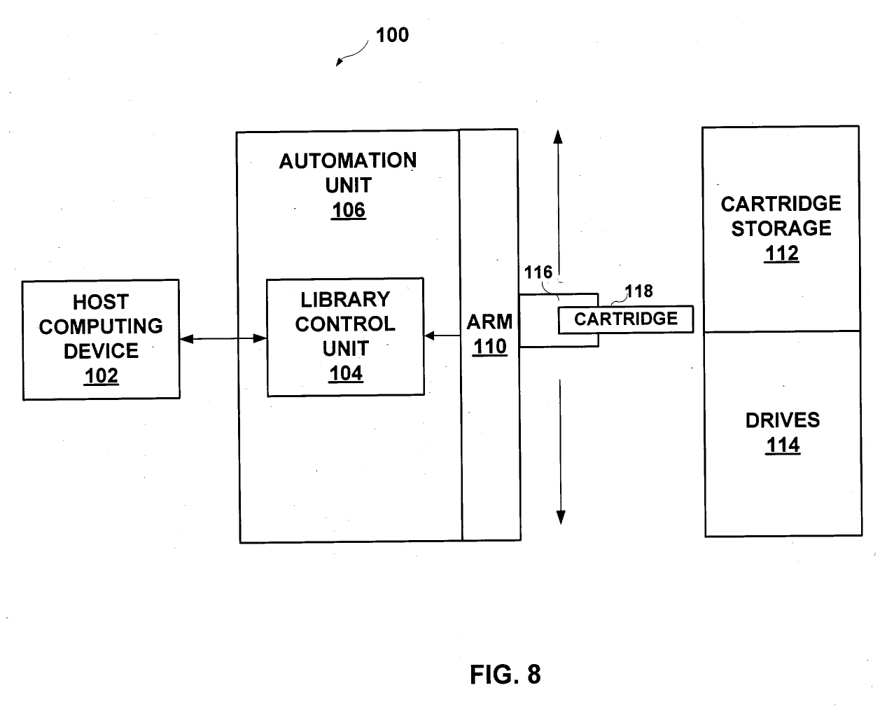

FIG. 8 is a block diagram illustrating an automated data tape cartridge library system 100 in which one or more data cartridges store data on a non-tape storage medium in a format that emulates the tape storage format. More specifically, automation unit 106 selectively retrieves data tape cartridge 118 and loads the retrieved data tape cartridge 118 into one of drives 114. When the drive is finished with the data tape cartridge 118, automation unit 106 retrieves the data tape cartridge 118 from the drive and returns it to the assigned storage location within cartridge storage 112.

Accordingly, cartridge storage 112 provides a plurality of data tape cartridge storage locations. Each location, also referred to as a cell, provides storage for a single data tape cartridge. Each data tape cartridge typically includes a housing having standard dimensions and features to be easily engaged by automation unit 106. In addition, the data tape cartridges may have some type of identifying information, such as a label, a bar code, or a radio frequency (RF) tag, by which the automation unit 106 identifies the individual data tape cartridges.

Host computing device 102 communicates with library control unit 104 to direct operation of data tape cartridge library system 100. In response to an access request from host computing device 102, library control unit 104 generates control signals to direct a robot arm 110 to retrieve the appropriate data tape cartridge from cartridge storage 112 and insert the data tape cartridge into one of drives 114. In particular, library control unit 104 interprets storage access requests from host computing device 102, and provides signals to control the motion and operation of robotic arm 110 and a gripper 116. In response to the signals, robotic arm 110 traverses cartridge storage 112 and engages a cartridge 118 using gripper 116. Upon insertion of data tape cartridge 118 into one of drives 114, host computing device 102 can write data to, and read data from, the data tape cartridge.

Cartridge storage 112 may include a number of conventional data tape cartridges housing magnetic tape, as well as a number of data cartridges housing non-tape storage media. The non-tape storage media store data in accordance with the techniques described herein, and may take the form of a variety of storage media, such as disk-shaped magnetic storage media, solid-state storage media, optical storage media, magneto-optical storage media, and holographic storage media.

Regardless of the type of internal storage media, the data cartridges have housings conforming to standard dimensions and features to be easily engaged by automation unit 106. Because the data tape cartridges conform to standard dimensions, cartridges housing different types of media are mechanically indistinguishable by automation unit 106. In this manner, the mechanical interfaces between automation unit 106 need not be adapted or upgraded to support non-tape media.

Furthermore, the data cartridges housing non-tape storage media may be self-contained storage devices that include necessary electronics and control circuitry for accessing the storage media. For example, a data cartridge may have standard external dimensions and features of a data tape cartridge, but may house a disk drive including the disk-shaped storage medium as well as the disk drive controller and read/write circuitry.

Accordingly, drives 114 may include one or more conventional tape drives and one or more tape drive emulators for receiving data cartridges housing non-tape storage media. In other words, drives 114 may include one or more tape drive emulators such that the non-tape storage media appear to host computing device 102 as sequential storage devices. Specifically, the tape drive emulators communicate with host computing device 102 as conventional tape drives. For example, in response to a query from host computing device 102, the tape drive emulators may identify themselves as conventional tape drives, such as a standard 3480 tape drive. Consequently, the drivers and other software applications executing on host computing device 102 for accessing tape-based data tape cartridges need not be modified.

As with the data cartridges carrying non-tape media, the tape drive emulators may be physically configured for use with conventional backup infrastructure, such as library system 100. For example, the tape drive emulators may conform to standard dimensions and form factors of conventional tape drives that may readily be inserted within a drive bay of library system 100. The tape drive emulators may, for example, have appropriately located power connectors, mounting holes and electrical sockets for receiving data tape cartridges carrying non-tape media.

In this manner, data cartridges housing non-tape storage media physically appear the same as magnetic data tape cartridges from the perspective of automation unit 106, and functionally appears the same from the perspective of host computing device 102. Accordingly, a wide variety of storage media may be used within library automation system 100 with little or no change to automation unit 106 or host computing device 102.

One or more of the data cartridges housing non-tape storage media may contain a plurality of disk drives, in accordance with the techniques described herein. Moreover, RAID functionality may be incorporated directly within one or more of drives 114, within one or more of the data cartridges, within host computing devices 102, or combinations thereof.

Although described in reference to library system 100, the principles of the invention are not limited to automated data tape cartridge systems. A system administrator or other user may, for example, manually insert the data tape cartridges into drives 114. In addition, library system 100 can easily be migrated to larger storage capacities without upgrading drives 114. Unlike conventional systems in which the drives must be upgraded to support larger capacity magnetic data tape cartridges, the tape drive emulators can readily support non-data tape cartridges having increased storage capacities. For example, the tape drive emulators may readily detect the storage capacity of inserted data cartridges having non-tape storage media, possibly by querying the header stored by the media as described above, and report the storage capacity to host computing device 102. In this manner, library system 100 can be viewed as forward compatible with ensuing data cartridges having non-tape storage media of increased storage capacity.

Various embodiments of the invention have been described. Nevertheless, it is understood that various modifications can be made without departing from the spirit and scope of the invention. These and other embodiments are within the scope of the following claims.

1. A device comprising:
a data tape cartridge housing that defines a form factor that conforms to an industry standard form factor for data tape cartridges; and
a plurality of disk drives contained within the data tape cartridge housing.

2. The device of claim 1, wherein the plurality of disk drives comprises a first and second disk drive, and the device comprises a printed circuit having electrical connectors to receive the first and second disk drives.

3. The device of claim 2, wherein the printed circuit comprises:
a first electrical connector connected to an upper surface of the printed circuit to receive the first disk drive; and
a second electrical connector connected to a lower surface of the printed circuit to receive the second disk drive.

4. The device of claim 2, wherein the printed circuit comprises an electrical edge connector for electrically engaging a tape drive emulator.

5. The device of claim 1, wherein each of the plurality of disk drives comprises:
a disk-shaped storage medium;
a disk drive controller to control access to the disk-shaped storage medium; and
a housing to contain the disk drive controller and the disk-shaped storage medium.

6. The device of claim 5, wherein the disk-shaped storage medium is selected from an optical storage medium, a magnetic storage medium, a magneto-optical storage medium, and a holographic storage medium.

7. The device of claim 1, wherein each of the disk drives contained within the data tape cartridge housing has a height of less than 10 mm.

8. The device of claim 1, wherein the plurality of disk drives comprises two disk drives having dimensions of approximately 100 mm×70 mm×10 mm.

9. The device of claim 1, further comprising a controller contained within the housing and coupled to the disk drives to control storage and retrieval of the data from the disk drives.

10. The device of claim 9, wherein the controller writes the data to one of the disk drives, and writes a duplicate copy of the data to the other disk drive.

11. The device of claim 9, wherein the controller writes a first portion of the data to one of the disk drives, and writes a second portion of the data to the other disk drive.

12. The device of claim 1, wherein the controller comprises a Redundant Array of Independent Disks (RAID) controller.

13. A tape drive emulator comprising a controller that receives a data tape cartridge housing defining a form factor that conforms to an industry standard form factor for data tape cartridges, and stores data on a plurality of disk drives contained within a data tape cartridge housing.

14. The tape drive emulator of claim 13, wherein the controller writes the data to a first one of the disk drives, and writes a duplicate copy to a different one of the disk drives.

15. The tape drive emulator of claim 13, wherein the controller writes a first portion of the data to one of the disk drives, and writes a second portion of the data to a different one of the disk drives.

16. The tape drive emulator of claim 13, wherein the controller comprises a RAID controller to control the storage of data by the plurality of disk drives.

17. The tape drive emulator of claim 13, further comprising a user interface to receive a mode input to programmatically select between a first mode in which the controller writes duplicate data to a subset of the disk drives and a second mode in which the controller stripes data across the disk drives.

18. The tape drive emulator of claim 13, wherein the controller stores the data on the disk drives in accordance with a format that emulates a tape storage format.

19. The tape drive emulator of claim 13, wherein each of the disk drives comprises:
a disk-shaped storage medium;
a disk drive controller to control access to the disk-shaped storage medium; and
a housing to contain the disk drive controller and the disk-shaped storage medium.

20. The tape drive emulator of claim 13, wherein each of the disk drives contained within the data tape cartridge housing has a height of less than 10 mm.

21. The tape drive emulator of claim 13, wherein the tape drive emulator receives the data tape cartridge in which the plurality of disk drives comprises two disk drives having dimensions of approximately 100 mm×70 mm×10 mm.

22. A system comprising:
a data tape cartridge housing that contains a plurality of disk drives, wherein the data tape cartridge housing conforms to industry standard dimensions for magnetic data tape cartridges;
a tape drive emulator to receive the data tape cartridge housing and store data within the plurality of disk drives in accordance with a format that emulates a tape storage format;
a host computing device to communicate the data to the tape drive emulator via a tape drive communication protocol; and
an automation unit to selectively retrieve the data tape cartridge housing from a data tape cartridge library and engage the data tape cartridge housing with the tape drive emulator.

23. The system of claim 22, wherein the plurality of disk drives comprises a first and second disk drive, and the data tape cartridge housing contains a printed circuit having electrical connectors to receive the first and second disk drives.

24. The system of claim 23, wherein the printed circuit comprises:
a first electrical connector connected to an upper surface of the printed circuit to receive the first disk drive;
a second electrical connector connected to a lower surface of the printed circuit to receive the second disk drive; and
an electrical edge connector for electrically engaging the tape drive emulator.

25. The system of claim 22, wherein each of the disk drives contained within the data tape cartridge housing comprises:
a disk-shaped storage medium;
a disk drive controller to control access to the disk-shaped storage medium; and
a housing to contain the disk drive controller and the disk-shaped storage medium.

26. The system of claim 22, wherein the data tape cartridge housing conforms to an industry standard form factor, and each of the disk drives has a height of less than 10 mm.

27. The system of claim 22, further comprising a RAID controller to control storage of the data to the physical disk drives contained within the data tape cartridge housing.

28. The system of claim 27, wherein the RAID controller is contained within one of the tape drive emulator or the data tape cartridge housing.

29. The system of claim 28, wherein the tape drive emulator comprises a user interface to configure the RAID controller.

30. A system comprising:
a plurality of tape drive emulators to receive data tape cartridge housings that contain one or more non-tape storage media and that conform to industry standard dimensions for magnetic data tape cartridges, wherein the tape drive emulators store data within the contained non-tape storage media in accordance with a format that emulates a tape storage format;
a host computing device to communicate the data to the tape drive emulators via a tape drive communication protocol; and
a RAID controller to control storage of the data to the tape drive emulators.

31. The system of claim 30, wherein in a first mode the RAID controller writes the data to a first subset of the tape drive emulators and writes a duplicate copy of the data to a different subset of the tape drive emulators.

32. The system of claim 30, wherein the RAID controller writes a first portion of the data to a first subset of the tape drive emulators, and writes a second portion of the data to a different subset of the tape drive emulators.

33. A method comprising:
receiving data from a host computing device in accordance with a tape drive communication protocol; and
storing the data on a plurality of disk drives contained within a data tape cartridge housing in accordance with a selectable storage mode.

34. The method of claim 33, wherein storing the data comprises:
writing the data to a first one of the disk drives and a duplicate copy of the data to a second one of the disk drives when a first storage mode is selected; and
writing a first portion of the data to the first one of the disk drives and a second portion of the data to the second one of the disk drives when a second storage mode is selected.

35. A system comprising:
a removable cartridge that contains a plurality of disk drives;
a host computing device to store data on the plurality of disk drives; and
an automation unit to selectively retrieve the cartridge from a library for access by the host computing device.

36. The system of claim 35, wherein the housing comprises a data tape cartridge housing that conforms to industry standard dimensions for magnetic data tape cartridges.

37. The system of claim 35, further comprising a RAID controller to control storage of the data to the physical disk drives contained within the housing.

38. The system of claim 37, wherein the RAID controller is contained within one of the removable cartridge, the host computing device, or the automation unit.
